(19) United States
(12) Patent Application Publication
(10) Pub. No.: US 2007/0061992 A1
(43) Pub. Date: Mar. 22, 2007

(54) Apparatus for precise placement of paint medium

(76) Inventor: Paul Carson Plyler, Oceanside, CA (US)

Correspondence Address: PAUL CARSON PLYLER, 1624 KURTZ ST, OCEANSIDE, CA, 92054, US

(21) Appl. No.: 11/523,859

(22) Filed: Sep. 20, 2006

Related U.S. Application Data
(63) Continuation of application No. 60/719,257, filed on Sep. 21, 2005.

(51) Int. Cl. B05C 17/10

(52) U.S. Cl. 15/245.1

(57) ABSTRACT

An apparatus for precise placement of paint medium with a miniature size paint application palette knife, and a miniature palette knife with multiple blade configurations to produce various effects, and a miniature palette knife that because of its miniature paint application surface permits the placement of painting medium in fine lines and small details not attainable with larger instruments, a miniature palette knife that allows artists to save expensive paint medium by applying the medium one time precisely rather than multiple times with a larger instrument until the desired effect is achieved

### CROSS REFERENCE TO RELATED APPLICATIONS

This application is based on provisional application Ser. No. 60/719/257, filed on Sep. 21, 2005.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of devices for paint medium application and manipulation and more specifically to an apparatus for precise placement of paint medium. The present invention relates to applicators and manipulators having a paint application surface to produce various textures and effects on artwork. The present invention also relates to the precise application of paint medium to artwork in a precise location and manner not readily achievable with larger instruments.

### History of Technology

Since the beginning of time artists have applied their paint medium by various means. They have used sticks, feathers, fingers, hands, and other means. As time progressed and painting became a more refined, precise work, the use of bristle brushes and other paint medium application tools, including but not limited to, palette knives and painting knives. These brushes and paint application devices evolved over time into various sizes and shapes to produce a variety of strokes and effects. Today there are many choices for artists to select from. The palette knife is one such choice because it can produce a variety of effects not readily achievable with a brush, such as texture, dimension, mottled effects, superimposed planes, gradations, impasto, and lined effects. These effects achieved by the palette knife produce artwork with greater texture and interest.

### Prior Technology

There have been palette knives produced throughout the history of art to manipulate paint medium in various ways. As shown in U.S. Pat. No. 2,861,371 to Leshik discloses types of steel spatulas. U.S. Pat. Nos. 2,099,030 and 2,147,310 to Morrison discloses types of rubber spatulas for paint manipulation. U.S. Pat. No. 6,608,371 B1 to Forsline discloses a silicone paint brush artists' tool. This tool includes a handle and a painting tip made of a resilient silicone. This tool is designed to blend and move the paint medium much like a “squeegee”.

### Deficiency in Prior Technology

The tools previously mentioned in prior technology which includes steel spatulas, rubber spatulas, silicone tipped painting devices, including palette knives all have the benefit of easy cleaning and a variety of shapes to produce a range of marks or effects. Because of their size, even the smallest palette knife does not permit the artist to see behind the blade the precise placement of the paint medium or the resultant effect produced by the stroke of the palette knife. The amount of medium applied and the effect avhieved is often not the desired result the first time applied. Thus the removal of the medium and re-application until the desired result is achieved. This is a time consuming process and wastes expensive paint medium.

### BRIEF SUMMARY OF THE INVENTION

The primary object of the invention is It allows the artist to see precisely the placement of the painting medium because of its size.

Another object of the invention is It allows greater detail to be achieved.

Another object of the invention is It saves painting medium because the results will be achieved with the first application rather than multiple applications with a larger tool.

A further object of the invention is It allows the beginner and the professional a greater level of skill and the ability to produce excellent results.

Yet another object of the invention is It is easy to use and does not require special training.

Still yet another object of the invention is It is not expensive to manufacture. Another object of the invention is It is made of readily available materials. Another object of the invention is It reduces the level of frustration from having to use a larger tool and not getting the desired results the first time.

Other objects and advantages of the present invention will become apparent from the following descriptions, taken in connection with the accompanying drawings, wherein, by way of illustration and example, an embodiment of the present invention is disclosed.

### SUMMARY

In accordance with a preferred embodiment of the invention, there is disclosed apparatus for applying art medium comprising: an applicator with multiple benefits, a handle having a distal end and a proximal end, a stainless steel blade attached to the distal end, and a metal band attached to the distal end.

In accordance with a preferred embodiment of the invention, there is a disclosed apparatus for applying art medium comprising: an applicator that because of its miniture size allows artists to save expensive paint medium by applying the medium one time precisely, rather than multiple times with larger instruments until the desired effect is achieved. You cannot see the point of contact or the effect achieved with a larger instrument.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a side view of the miniature palette knife showing the basic size and shape of the paint application and manipulation apparatus;

FIG. 2 is a plan view of the apparatus of FIG. 1;

FIG. 3 is an end view of the apparatus of FIG. 1;

FIG. 4 is a bottom blade surface plan view of the apparatus of FIG. 1 showing the blade sizes;

FIG. 5 is a plan view of the apparatus of FIG. 1 showing the blade shapes;

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

### DETAILED DESCRIPTION

Apperceptive knowledge of the said invention can be obtained in accordance with the drawings and a thorough examination of the following explanation. An overview of the preferred embodiments is provided. In addition to the overview, a detailed explanation of other alternative embodiments is also provided.

The said invention is a device for applying paint medium in a precise and detailed manner; that because of its novel feature of its miniature size allows the artist to precisely apply the paint which may include but is not limited to oil paint, acrylic paint, and other paint substances with the same or similar viscosity. This device of invention comprising but not limited to providing the same benefits as traditional larger palette knives, yet because of the miniture paint application surface provides multiple benefits.

As shown in FIG. 1 the said apparatus 10 having a handle 16 with a proximal end 20 and a distal end 22. The handle 16 may be formed of wood with hardwood the primary choice finished with shellac, enamel, varnish, lacquer. The handle 16 may alternatively be formed of metal or plastic.

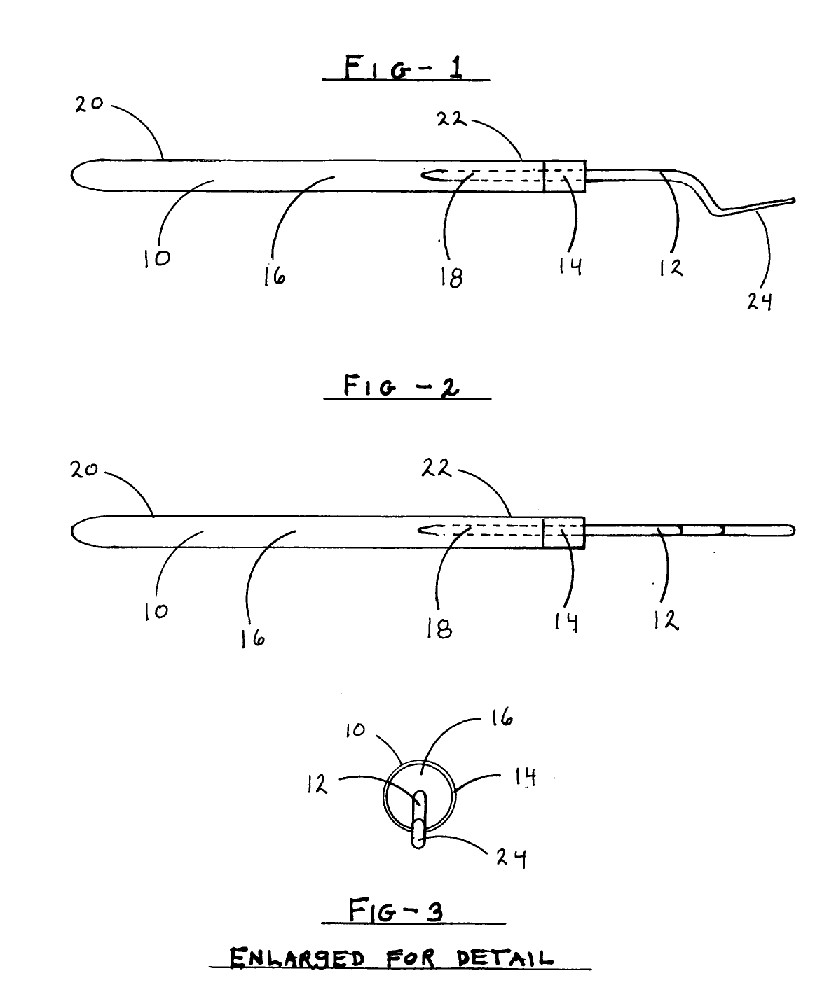

Attached to the distal end 22 of the apparatus 10 is the stainless steel mini knife polished blade 12. The blade 12 in a preferred embodiment the material may be stainless steel, steel, brass, copper, aluminum, or plastic. As shown in FIG. 1 & 2 the stainless steel mini knife polished blade 12 is preferably attached to the distal end 22 of the handle 16 by insertion into a prepared orifice 18. This is a tight pressed fit and no other adhesives or retention methods are required. As shown in FIG. 1, FIG. 2, and FIG. 3 the metal band 14 is attached to the distal end 22 of the handle 16 of said device by means of a tight pressed fit and no other adhesive or rentention methods are required. This metal band 14 is tight and prevents the handle 16 from splitting with constant use.

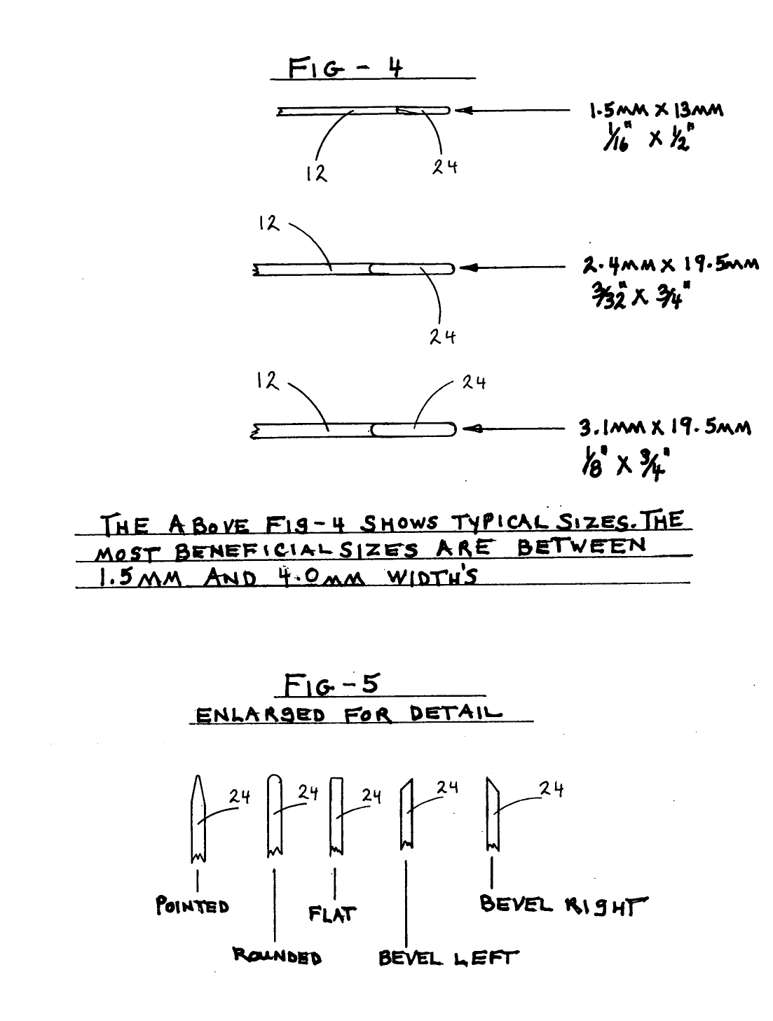

As shown in FIG. 4 the stainless steel mini knife blade 12 comprised of a paint medium application surface 24 in the most beneficial sizes of 1.5 mm×13 mm for small size artwork, 2.4 mm×19.5 mm for medium size artwork, and 3.1 mm×19.5 mm for larger artwork not to exceed 4.0 mm width. which begins to excede the visual range for precise application and into the range of larger instruments, which sizes diminish the purpose and usefulness rather than that produced by larger instruments in precise placement and visual acuity to the artwork.

As shown in FIG. 4, the sizes of the paint medium application surfaces 24 permits the transfer of paint from pallet or container to the painting or artwork one time precisely, to a specific location which location would be covered by a larger palette knife blade; and the artist could not determine how much paint had been applied or the effect achieved by a larger instrument. The reapplication of paint medium multiple times to the desired location would waste expensive paint medium.

As shown in FIG. 4 and FIG. 5 the mini knife blade 12 and the miniature paint application surface 24 comprises various blade end configurations. These blade end configuration 24 types are comprised of but not limited to pointed, round, flat, beveled left, and beveled right.

In the preferred embodiment the sizes and shapes of the said apparatus 10 as described herein and disclosed in FIG. 1, FIG. 2, FIG. 3, FIG. 4, and FIG. 5 are the most beneficial.

In an alternative embodiment of the present invention and in personal preference of artists, the blade 12 length and shape can be lengthened or bent into unlimited variations until shapes are produced that replicate repetetive designs, textures, details, fine lines or mottled effects.

In summary, it can be determined that the present invention in its present and various embodiments produce a new and extremely useful artist tool, comprising a device not heretofore attainable in the art tool sperctrum. Because of the many deviations and modifications that can be made to this invention, the scope of the invention is not limited to a single embodiment illustrated or described. The scope of the invention is to be determined by the written references descriptions, drawings, and claims and their equivalents.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus for precise placement of paint medium comprising;
A miniature size paint application palette knife; and
A miniature palette knife with a miniture paint application surface and multiple blade configurations to produce various effects; and
A miniature palette knife that permits the placement of painting medium in fine lines and small details not attainable with larger instruments; and a miniature palette knife that because of its size allows the artist to apply the paint one time precisely rather than multiple times with a larger instrument until the desired effect is achieved, which would waste expensive paint medium.
